(19) United States
(12) Patent Application Publication
(10) Pub. No.: US 2024/0113391 A1
(43) Pub. Date: Apr. 4, 2024

(54) NANODIAMOND-ENHANCED NANOFIBER SEPARATOR FOR ELECTROCHEMICAL ENERGY STORAGE DEVICES

(71) Applicants: Georgia Tech Research Corporation, Atlanta, GA (US); Daicel Corporation, Tokyo (JP)

(72) Inventors: Aashray Narla, Atlanta, GA (US); Wenbin Fu, Atlanta, GA (US); Kostiantyn Turcheniuk, Atlanta, GA (US); Gleb Yushin, Atlanta, GA (US); Atsushi Kume, Tokyo (JP)

(73) Assignees: Georgia Tech Research Corporation, Atlanta, GA (US); Daicel Corporation, Tokyo (JP)

(21) Appl. No.: 18/208,431

(22) Filed: Jun. 12, 2023

Related U.S. Application Data
(60) Provisional application No. 63/413,070, filed on Oct. 4, 2022.

(30) Foreign Application Priority Data
Mar. 30, 2023 (JP) 2023-055158

(51) Int. Cl. H01M 50/446; H01M 10/0525; H01M 50/403; H01M 50/426; H01M 50/44; H01M 50/491

(52) U.S. Cl. CPC H01M 50/446; H01M 10/0525; H01M 50/403; H01M 50/426; H01M 50/44; H01M 50/491

(57) ABSTRACT

The present disclosure relates to Li-ion battery with an anode, a cathode, a porous separator membrane, and an electrolyte that fills pores in the anode, the cathode, and the porous separator membrane; and a porous separator membrane and methods of generating the same.

### BACKGROUND

### Field

The present disclosure relates generally to energy storage devices, and, for example, to battery technology, supercapacitor technology and the like.

### Background

Owing in part to their relatively high energy densities, relatively high specific energy, relatively high specific power, relatively fast charging, light weight, and potential for long lifetimes and cycle life, advanced rechargeable batteries and electrochemical capacitors are desirable for a wide range of electronic devices, electric vehicles, grid storage and other important applications.

However, despite the increasing commercial prevalence of electrochemical energy storage technologies, further development of the batteries and electrochemical capacitors is needed, particularly for potential applications in low- or zero-emission, hybrid-electrical or fully electric vehicles, consumer electronics, energy-efficient cargo ships and locomotives, aerospace applications, and power grids. Further improvements are desired for various rechargeable batteries, such as rechargeable metal and metal-ion batteries (such as rechargeable Li metal and Li-ion batteries, rechargeable Na metal and Na-ion batteries, rechargeable Mg metal and Mg-ion batteries, rechargeable K metal and K-ion batteries, rechargeable Ca metal and Ca-ion batteries, etc.). The following energy storage devices may similarly benefit from the additional improvements: rechargeable halogen-ion batteries (such as F-ion and Cl-ion batteries, etc.), rechargeable aqueous batteries (e.g., rechargeable batteries with pH-neutral or acidic or caustic electrolytes), electrochemical capacitors (e.g., supercapacitors or double layer capacitors), hybrid devices, rechargeable polymer electrolyte batteries and supercapacitors, rechargeable polymer gel electrolyte batteries and supercapacitors, to name a few.

In many different types of rechargeable batteries (e.g., in Li and Li-ion), separator membranes are typically made from polyolefins such as polypropylene (PP) and polyethylene (PE). Such separators commonly suffer from low porosity, low wettability and slow ionic conductivity and tend to perform poorly against heat-triggering reactions that may cause potentially catastrophic issues, such as fires.

Accordingly, there remains a need for improved separator materials and battery manufacturing processes.

### BRIEF DESCRIPTION OF THE DRAWINGS

The accompanying drawings are presented to aid in the description of embodiments of the invention and are provided solely for illustration of the embodiments and not limitation thereof.

FIG. 1 illustrates an exemplary (e.g., Li-ion) battery in which the components, materials, methods, and other techniques described herein, or combinations thereof, may be applied according to various embodiments.

FIG. 2 items a-b illustrate an example of suitable manufacturing method for the synthesis of nanodiamond (ND) containing nanofiber separator and possible separator advantages over traditional (e.g., PP-based) separator in Li or Li-ion batteries.

FIG. 3 items a-b illustrate an example of X-ray diffraction (XRD) and Fourier Transform Infrared Spectroscopy (FTIR) patterns of a suitable polymer without and with incorporation of illustrative fractions of ND.

FIG. 4 items a-f illustrate example scanning electron microscopy (SEM) and transmission electron microscopy (TEM) images of illustrative poly(vinylidene fluoride-co-hexafluoropropylene) (PVDF-HFP) separator containing 1 wt % and 5 wt % ND.

FIG. 5 items a-d illustrate example tests on thermal stability of different example separator membranes, showing shape retention when heated to different temperatures from 50 to 175° C. (kept 20 min at each temperature), differential scanning calorimetry (DSC), shape-retention upon exposing separator membranes to 130° C. for up to 10 days, strength-strain plots of ND-containing PVDF-HFP membranes after hot pressing under suitable conditions.

FIG. 6 items a-d illustrate example DSC cycles of pure PVDF-HFP (0 wt % ND), PVDF-HFP@1% ND (1 wt % ND) and PVDF-HFP@5% ND (5 wt % ND) separator membranes, as well as provides a graphical representation of how semi-crystalline polymer may be potentially disrupted by NDs to form disordered polymer chains and additionally shows Li⁺ diffusion coefficients of an illustrative electrolyte-filled PVDF-HFP membranes with different mass fractions of NDs, as calculated by nuclear magnetic resonance (NMR) spectroscopy.

FIG. 7 items a-d illustrates example electrochemical performance characteristics of cells containing intercalation-type lithium nickel cobalt manganese oxide (NCM) cathode, Li metal anode and several separators (commercial Celgard 2400 and PVDF-HFP@5% ND separators), such as cycling performance in the potential range 2.8-4.4 V, voltage profiles at different stages of cycling, longer-term cycling performance and voltage profile of the cells at C/3 between 2.8-4.2 V. 1 M LiPF₆ in ethylene carbonate/diethyl carbonate (EC/DEC) was used as electrolyte in these illustrative cells.

FIG. 8 items a-f illustrate examples of the top-view and cross-section SEM images of the Li anode from the cell with PVDF-HFP@5% ND separator and commercial PP separator after cycling.

FIG. 9 illustrates example of the FTIR of PVDF-HFP@5% ND membranes before and after hot press.

FIG. 10 illustrates examples of area reduction for commercial and ND-based membranes during storage at 130° C. for 250 h.

FIG. 11 illustrates example of diffusion coefficients of ¹H, ⁷Li and ¹⁹F for membrane samples with different ND concentrations at 25 and 40° C.

FIG. 12 illustrates example of voltage hysteresis of the cells using commercial and PVDF-HFP@5% ND separators.

FIG. 13 illustrates example cyclic voltammetry (CV) curves of the cells with PVDF-HFP@5% ND separator at a scan rate of 0.2 mV/s as well as Nyquist plots of the cells before and after long-term cycling at C/2 rate.

### DETAILED DESCRIPTION

Aspects of the present invention are disclosed in the following description and related drawings directed to specific embodiments of the invention. The term “embodiments of the invention” does not require that all embodiments of the invention include the discussed feature, advantage, process, or mode of operation, and alternate embodiments may be devised without departing from the scope of the invention. Additionally, well-known elements of the invention may not be described in detail or may be omitted so as not to obscure other, more relevant details.

While the description below may describe certain examples in the context of Li and Li-ion batteries (for brevity and convenience, and because of the current popularity of Li technology), it will be appreciated that various aspects may be applicable to other rechargeable and primary batteries (such as Na-ion, Mg-ion, K-ion, Ca-ion and other metal-ion batteries, alkaline batteries with OH⁻ ions, mixed ion batteries, etc.) as well as electrochemical capacitors (often referred to as supercapacitors or pseudocapacitors) or hybrid devices (e.g., with one electrode being battery-like and another electrode being electrochemical capacitor-like).

While the description below may also describe certain examples of the active electrode material belonging to specific intercalation-type active material(s), it will be appreciated that various aspects may be applicable to so-called conversion-type or alloying-type active material(s), so-called pseudocapacitive active materials, so-called double-layer capacitor-type active materials as well as mixed type active materials (or components of active materials) that may store charge by more than one mechanisms (e.g., active materials that exhibit both intercalation and conversion-type electrochemical reactions during cell operation or active materials that exhibit both intercalation and pseudo capacitance or active materials that exhibit both intercalation and double layer capacitors, among many other combinations).

While the description below may also describe certain examples of liquid organic electrolytes as components of electrochemical cells (batteries or electrochemical capacitors), it will be appreciated that various aspects may be applicable to various other liquid organic electrolytes, aqueous electrolytes, ionic salt electrolytes, molten salt electrolytes, polymer electrolytes, gel electrolytes, composite electrolytes, and others.

During battery (such as a Li-ion battery) operation, intercalation-type active materials operate by insertion (intercalation) and extraction (de-intercalation) of Li ions into/from the interstitial positions (nanoscale or sub-nanoscale voids) present in crystalline or disordered or fully amorphous structure of such intercalation compounds. This intercalation/de-intercalation process is accompanied by the changes in the oxidation state of the non-Li atoms (ions) (e.g., such as transition metal ions). Chemical bonds typically don't break or reform during such processes. Li ions diffuse in/out of the active materials.

During battery (such as a Li-ion battery) operation, conversion materials change (convert) from one crystal structure to another (hence the name “conversion”-type). During (e.g., Li-ion) battery operation, Li ions are inserted into alloying type materials forming lithium alloys (hence the name “alloying”-type). Sometimes, “alloying”-type electrode materials (commonly metals and semimetals) are considered to be a sub-class of “conversion”-type electrode materials. “Alloying”-type electrode materials may also include other type(s) of conversion materials (such as oxides, hydrides, nitrides, phosphides, etc.) as minor (0.1-50 wt %) additions as well as less active materials (which may exhibit significantly lower, 0.01%-30% of the alloying material gravimetric capacity) that may help to enhance mechanical or electrochemical stability of the alloying materials or enhance their electrical conductivity in a delithiated state (these may be intercalation-type materials). The electrochemical reaction processes between Li ions and alloying or conversion materials are accompanied by the breakage of some of the original and the formation of new chemical bonds. In an ideal case, the process is somewhat reversible and only little (or no) loss of active material (or Li) takes place during the battery operation (e.g., preferably no more than 30% during the lifetime of a battery).

While the description below may describe certain examples in the context of metal-ion batteries, other conversion-type electrodes that may benefit from various aspects of the present disclosure include various chemistries used in a broad range of aqueous batteries, such as alkaline batteries, metal hydride batteries, lead acid batteries, etc. These include, but are not limited to, various metals (such as iron, zinc, cadmium, lead, indium, etc.), metal oxides, metal hydroxides, metal oxyhydroxides, and metal hydrides, to name a few.

While the description below may describe certain examples of ceramic nanoparticles in the context of carbon-based nanoparticles, it will be appreciated that various aspects may be applicable to other types of ceramic nanoparticles, including oxide-based or oxide-containing nanoparticles, nitride-based or nitride-containing nanoparticles, carbide-based or carbide-containing nanoparticles, fluoride-based or fluoride-containing nanoparticles, to provide a few illustrative examples.

As used herein, the term “about” means modifying, for example, lengths, degrees of errors, dimensions, the quantity of an ingredient in a composition, concentrations, volumes, process temperature, process time, yields, flow rates, pressures, and like values, and ranges thereof, refers to variation in the numerical quantity that may occur, for example, through typical measuring and handling procedures used for making compounds, compositions, concentrates or use formulations; through inadvertent error in these procedures; through differences in the manufacture, source, or purity of starting materials or ingredients used to carry out the methods; and like considerations. The term “about” also encompasses amounts that differ due to aging of, for example, a composition, formulation, or cell culture with a particular initial concentration or mixture, and amounts that differ due to mixing or processing a composition or formulation with a particular initial concentration or mixture. Whether modified by the term “about” the claims appended hereto include equivalents to these quantities. The term “about” further may refer to a range of values that are similar to the stated reference value. In certain embodiments, the term “about” refers to a range of values that fall within 10, 9, 8, 7, 6, 5, 4, 3, 2, 1 percent or less of the stated reference value.

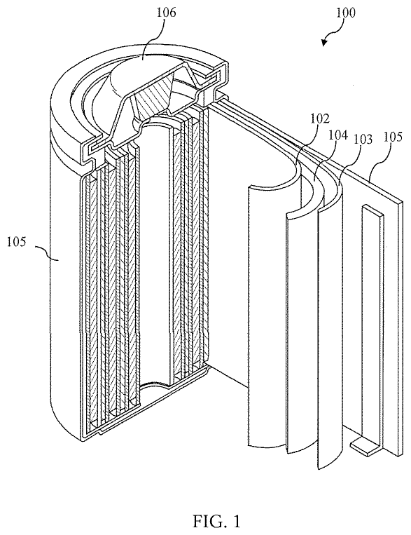

FIG. 1 illustrates an example metal-ion (e.g., Li-ion) battery in which the components, materials, methods, and other techniques described herein, or combinations thereof, may be applied according to various embodiments. A cylindrical battery is shown here for illustration purposes, but other types of arrangements, including prismatic or pouch (laminate-type) batteries, may also be used as desired. The example battery 100 includes an anode 102, a cathode 103, a separator 104 interposed between the anode 102 and the cathode 103 and electrically separating the anode 102 and the cathode 103, an electrolyte (not shown) impregnating the separator 104, a battery case 105, and a sealing member 106 sealing the battery case 105. The electrolyte fills the pores in the anode 102, the cathode 103, and the separator 104, and connects the anode 102 and the cathode 103 via ions.

Both liquid and solid electrolytes may be used for the designs herein. Conventional electrolytes for Li- or Na-based batteries of this type are generally composed of a single Li or Na salt (such as LiPF₆ for Li-ion batteries and NaPF₆ or NaClO₄ salts for Na-ion batteries) in a mixture of organic solvents (such as a mixture of carbonates). Other common organic solvents that may be utilized include, but are not limited to nitriles, sulfones, sulfoxides, phosphorous-based solvents, silicon-based solvents, ethers, and others. Such solvents may be modified (e.g., be sulfonated or fluorinated). The electrolytes may also include ionic liquids (in some designs, neutral ionic liquids; in other designs, acidic and basic ionic liquids). The electrolytes may also include mixtures of various salts (e.g., mixtures of several Li salts or mixtures of Li and non-Li salts for rechargeable Li and Li-ion batteries).

The most common salt used in a Li-ion battery electrolyte, for example, includes LiPF₆, while less common but suitable salts include lithium tetrafluoroborate (LiBF₄), lithium perchlorate (LiClO₄), lithium bis(oxalato)borate (LiB(C₂O₄)₂, lithium difluoro(oxalate)borate (LiBF₂(C₂O₄)), various lithium imides (such as SO₂FN⁻(Li⁺)SO₂F, CF₃SO₂N⁻(Li⁺)SO₂CF₃, CF₃CF₂SO₂N⁻(Li⁺)SO₂CF₃, CF₃CF₂SO₂N⁻(Li⁺)SO₂CF₂CF₃, CF₃SO₂N⁻(Li⁺)SO₂CF₂OCF₃, CF₃OCF₂SO₂N⁻(Li⁺)SO₂CF₂OCF₃, C₆F₅SO₂N⁻(Li⁺)SO₂CF₃, C₆F₅SO₂N⁻(Li⁺)SO₂C₆F₅ or CF₃SO₂N⁻(Li⁺)SO₂PhCF₃, and others), and others. In some designs, more than one Li salts may advantageously be used in electrolytes.

Despite the advances in Li-ion and Lithium-metal batteries (LIBs), many safety concerns still remain, which could hinder their wide-scale adoption. Separators 104, an inactive component in batteries, do not directly participate in redox events but physically separate battery anode and cathode, prevent short circuits and serve as reservoirs of liquid electrolytes and as conduits for Li-ion transport between the electrodes. In general, separators play a pronounced role in determining battery rate capability, lifespan and perhaps most importantly, safety. Conventional commercial separators are typically made from thermoplastic polyolefins such as polyethylene (PE) and polypropylene (PP), and they can be produced at large scale but they tend to suffer from low porosity, poor thermal stability (excessive shrinking at elevated temperatures that may induce internal short), and high tortuosity, which may cause premature failures of cells having high energy density. As LIBs are cycled for extended periods of time, heat-triggered exothermic “thermal runaway” reactions may occur due to large overpotentials present in the cells. These reactions may lead to an overall increase of temperature in the cell, which may cause the separator to shrink, the solid electrolyte interphase (SEI) to break down, and eventually short-circuit, resulting in explosions and fires in some (fortunately rare) cases, a relatively common shortcoming in PE and PP separators. A separator that minimizes the overpotentials in the first place through a facile conduction of Li-ions, and that is aided with superior characteristics (i.e., thermally stable, and able to prevent shrinkage at high temperatures) to dissipate heat in the case of a thermal runaway, is highly desired to reduce the probability of short circuiting, improve cycle life, and ensure safety. Furthermore, a thin, porous, and ionically conductive separator is required for the next-generation Li batteries to garner the benefits of high-energy dense electrodes.

Polymer-nanoparticle composites could be of particular interest for the past two decades as candidates for separators in LIBs. Nanoparticles, inorganic or organic, when embedded in the polymer matrix (e.g., poly (vinylalcohol) and aramid) tend to improve mechanical, thermal and structural properties of the composites. Yet, shortcomings such as poor cycle life, large hysteresis, and complicated processing methods, still remain an issue for the reported composite separators, which calls for further innovations in their chemistry and engineering aspects.

Nanodiamonds (NDs) may be a relatively unexplored class of carbon nanoparticles featuring high surface-to-volume ratio, tunable size, for example, in the range from about 3 nm to about 60 nm, and surface functionalization, high elasticity moduli, and exceptional thermal conductivity. NDs may be used as an additive to liquid electrolytes to suppress the growth of lithium dendrites, and ND thin film may provide interfacial protection for Li metal anode. Some embodiments of the present disclosure provide a functionalized composite separator (porous separator membrane; hereinafter also referred to as “ND-containing separator membrane” or simply “separator”) based on NDs incorporated with nanofibers containing poly(vinylidene fluoride-co-hexafluoropropylene) (PVDF-HFP) and/or other polymer(s). The nanofibers are used as fillers such as cellulose nanofibers. In additional embodiments, the nanofibers have the average diameter in the range from about 20 nm to about 990 nm; in some designs—from about 20 nm to about 100 nm; in other designs, from about 100 nm to about 200 nm; in other designs, from about 200 nm to about 990 nm. In some embodiments, the nanofibers in the separator membrane described herein may have an average diameter from about 3, 5, 8, 10, 20, 30, 40, 50, 60, 70, 80, 90, 100, 110, 120, 130, 140, 150, 160, 170, 180, 190, 200, 210, 220, 230, 240, 250, 260, 270, 280, 290, 300 or 310 nm to about 100, 200, 300, 310, 320, 330, 340, 350, 360, 370, 380, 390, 400, 500, 600, 700, 800, 900 or 990 nm. Additional details about exemplary NDs described herein are disclosed in US2022/0064007, which is incorporated by reference in its entirety.

Furthermore, in addition to PVDF-HFP nanofibers, other suitable polymers or polymer matrices include, but are not limited to: PVDF and its copolymers, polyethylene (PE), polyimide (PI), poly (vinyl pyrrolidone) (PVP), polyacrylonitrile (PAN), poly(acrylic acid) (PAA), polyvinyl butyral (PVB), polyvinyl chloride (PVC), polycaprolactone (PCL), polyurethane (PU), poly(urethane acrylate) (PUA), poly(ethylene oxide) (PEO), polyvinyl alcohol (PVA), poly(ethylene glycol) diacrylate (PEGDA), polystyrene (PS), or poly (styrene-co-butadiene) (SBR), poly (ethylene terephthalate) (PET), poly-methyl-methacrylate (PMMA), polytetrafluoroethylene (PTFE), poly(1-lactide) (PLLA), poly aryl ether ketone (PAEK), polyether ether ketone (PEEK), polybenzimidazole (PBI), nylon, aramid and its variants, biopolymers such as cellulose, chitosan, chitin and their derivatives. In some embodiments, the nanofibers described herein may include one or more of different polymers.

Furthermore, in addition to nanofibers, microscopic fibers (e.g., with diameters of more than around 1 micron and preferably less than around 10 micron) may be used in some designs to, for example, improve mechanical properties of such separators.

In the porous separator membrane described above, the polymer is preferably in the form of nanofibers. Further, the NDs are preferably dispersed (particularly, uniformly dispersed) in the nanofibers in the form of powder. The polymer preferably includes at least one selected from the group consisting of PVDF, poly(hexafluoropropylene) (HFP), and PVDF-HFP copolymers.

To further confirm the attractive properties of ND-containing nanofiber-based separators, the electrochemical properties of these separators in LIBs using high-voltage intercalation-type LiNi_{0.8}Mn_{0.1}Co_{0.1}O₂ (NMC811) cathodes were explored. Other intercalation-type cathode materials (e.g., other types of layered lithium nickel or manganese oxide—based cathodes, such as various other types of lithium nickel manganese cobalt oxide (NCM); lithium nickel cobalt aluminum oxide (NCA), lithium cobalt oxide (LCO), various lithium manganese oxides or lithium manganese nickel oxides including but not limited to high-voltage spinels (LMO or LMNO), lithium iron phosphates (LFP), lithium manganese iron phosphate (LMFP) and other olivine-based cathodes, to name a few) may be used in some designs. Furthermore, conversion-type cathode and anode materials may similarly be utilized. Excellent performance of these separators in these cells has been observed.

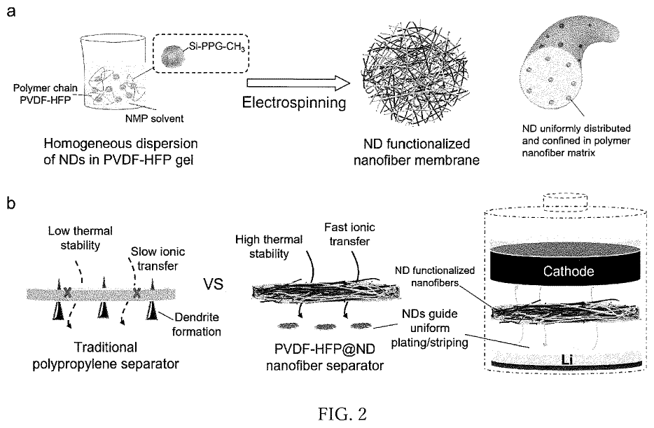

FIG. 2 shows an illustrative example of the ND-containing separator membrane fabrication and some of their advantages. In one illustrative example, ND-containing separator membranes were produced by electrospinning. The NDs are NDs containing a surface-modifying group containing a polypropylene glycol (PPG) chain (specifically, for example, ND-Si-PPG-CH₃), and were surface-functionalized using ball milling of PPG and silane coupling agent and then dispersed in N,N-dimethylacetamide (DMAc) to form and obtain a homogeneous dispersion. That is, the NDs contain a surface-modifying group having a structure derived from a silane coupling agent containing a PPG chain. The NDs have, for example, the structure shown in Formula (1) below. The silane coupling agent containing the PPG chain has the structure shown in Formula (2) below. Note that, in Formula (1) and Formula (2), atoms in the PPG that respectively bond to the methyl group and silicon atom are oxygen atoms.

—Si-PPG-CH₃ (1)

[In Formula (1), a bond extending from Si to the left bonds directly or indirectly to the ND.]

R₃—Si-PPG-CH₃ (2)

[In Formula (2), R indicates an identical or different alkoxy group.]

The surface-modifying group is not limited to a PPG chain, and modifying groups containing monovalent organic chains (especially bulky modifying groups with high steric hindrance), such as groups with poly(oxyalkylene) chains other than PPG, such as polyethylene glycol chains, and groups with polyglycerin chains are preferred for excellence in dispersibility. Preferably, the surface-modifying group contains a monovalent organic group (R¹ in Formula (3) below, for example) at the end. Examples include the structure of the group with a poly(oxyalkylene) chain described above in which the end of the poly(oxyalkylene) chain is encapsulated by a monovalent organic group.

Examples of a modifying group containing the organic chain described above include the group represented by Formula (3) below.

—X—R¹ (3)

[In Formula (3), X represents a linking group, and a bond extending from X to the left bonds to the ND. R¹ represents a monovalent organic group, and the atom bonded to X is a carbon atom.]

In the above Formula (3), X represents a linking group, and examples thereof include an amino group (—NR^{a}—), an ether bond (—O—), an ester bond (—C(═O)O—), a phosphinic acid group (—PH(═O)O—), a phosphonic acid group (—P(—OH)(═O)O—), a phosphate ester (—O—P(═OXOH)—O—), a sulfide bond (—S—), a carbonyl group (—C(═O)—), an amide group (—C(═O)—NR^{c}—), a urethane bond (—R^{a}H—C(═O)—O—), an imide bond (—C(═O)—NR^{a}—C(═O)—), a thiocarbonyl group (—C(═S)—), a siloxane bond (—Si—O—), a sulfuric acid ester group (—O—S(═O)₂—O—), a sulfonyl group (—S(═O)₂—O—), a sulfone group (—S(═O)₂—), a sulfoxide group (—S(═O)—), and groups in which two or more of these are bonded. In asymmetric divalent groups, the direction of the divalent group with respect to the ND side and the R side is not limited. R^{a} described above represents a hydrogen atom or a monovalent organic group. Examples of the monovalent organic group of RC include those exemplified and described as monovalent organic groups of R¹ described above.

Examples of the monovalent organic group of R¹ include a substituted or unsubstituted hydrocarbon group (monovalent hydrocarbon group), a substituted or unsubstituted heterocyclic group (monovalent heterocyclic group), and a group in which two or more of the aforementioned monovalent hydrocarbon groups and/or the monovalent heterocyclic groups are bonded. The bonded group may be directly bonded or bonded via a linking group. Examples of the linking group include an amino group, an ether bond, an ester bond, a phosphinic acid group, a sulfide bond, a carbonyl group, an organic group-substituted amide group, an organic group-substituted urethane bond, an organic group-substituted imide bond, a thiocarbonyl group, a siloxane bond, and groups in which two or more of these are bonded.

Other suitable surface coatings include, but are not limited to —COOH (carboxylic acid), —NH₃ (amine group), —H (hydrogen), —OH (hydroxyl group), —ODA (octadecylamine), acyl chlorides, or —F (fluorine). To prepare the polymer gel for electrospinning, PVDF-HFP and NDs in a mixed solvent was prepared by dissolving PVDF-HFP into a mixture of DMAc and acetone. Tip ultrasonication was conducted to improve the homogeneity of ND distribution in the polymer matrix (or the polymer component). ND is possibly attached on the surface of the polymer matrix. The resulting ND/PVDF-HFP/N-Methyl-2-pyrrolidone (NMP) mixed gel was electrospun onto an aluminum foil at a high voltage (in this example at 16 kV) to form a free-standing, non-woven membrane of PVDF-HFP nanofibers intercalated with NDs. As a suitable variation of such a process, the membrane could be directly deposited on the surface of one of the electrodes or on the surface of a base separator film. The membrane was then dried and hot pressed for future tests and use. For comparison, membranes with ND mass fractions of 0%, 1% and 5% (ND by weight relative to the polymer), which were denoted as PVDF-HFP, PVDF-HFP@1% ND and PVDF-HFP@5% ND, were produced. In general, commercial separators made from thermoplastic polyolefins such as PP or PE could suffer from low porosity, low heat resistance and slow ionic transport, leading to low-rate capability, and capacity degradation due to the sharp dendrite formation that may destroy the cathode particles in the vicinity. In contrast to these separators, ND-containing nanofiber membranes may overcome these difficulties, because the nanofiber network may offer a higher porosity and faster ion disunion diffusion, which could facilitate electrolyte uptake and Li transport. NDs could guide the uniform plating/striping of Li on the Li anode surface, without the formation of sharp dendrites. Besides, the hardness and thermal stability of NDs can also improve mechanical stability and thermal stability that allows cells to operate within a wider temperature range.

Suitable fraction (mass percentage) of ND in the ND-containing nanofiber membranes (or the polymer) may range from about 0.1 wt % to about 40 wt %; In some designs, from about 0.1 to about 1 wt %; in other designs, from about designs, from about 1 to about 5 wt %; in other designs, from about 5 to about 10 wt %; in other designs, from about 10 to about 20 wt %; and in yet other designs, designs, from about 20 to about 40 wt %, depending on the desired separator membrane characteristics, including size, porosity, strength, ductility, and/or thermal stability. In some embodiments, the fraction may be from about 0.1, 0.5, 1, 2, 3, 4, 5, 6, 7, 8, 9, 10, 15 or 20 wt % to about 5, 10, 15, 20, 25, 30, 35 or 40 wt %.

Suitable thickness of the ND-containing polymer fiber (or nanofiber) separators or separator layer may range from about 1 micron to about 40 microns; in some designs, from about 1 micron to about 5 microns; in other designs, from about 5 microns to about 10 microns; in other designs, from about 10 to about 20 microns; and in yet other designs, from about 20 to about 40 microns. In some embodiments, the thickness may be from about 1, 2, 3, 4, 5, 6, 7, 8, 9, 10 or 11 micron to about 10, 15, 20, 25, 30, 31, 32, 33, 34, 35, 36, 37, 38, 39 or 40 micron.

Suitable porosity of the ND-containing polymer fiber (or nanofiber) separators or separator layer may range from about 40 vol. % to about 90 vol. %, as estimated from the density measurements or mercury porosimetry or other suitable techniques.

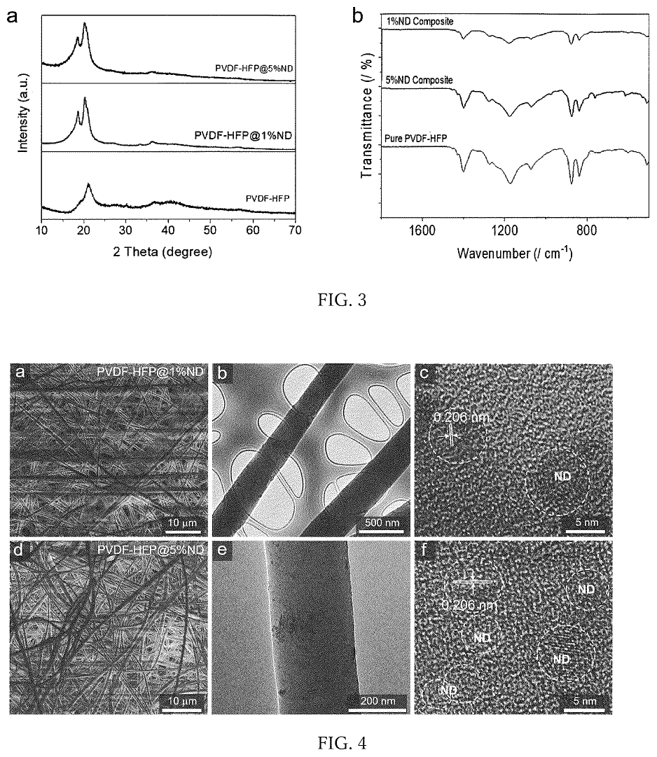

FIG. 3 shows illustrative examples of the X-ray diffraction (XRD) patterns of the ND-functionalized samples (both 1 and 5 wt %) that are similar to that of the pure PVDF-HFP, suggesting that ND incorporation did not change the packing of polymer significantly in the solid state. However, the employed ND concentration was too low to observe their characteristic diffraction peaks. To further identify their chemical bonding features in the membranes, Fourier transform infrared spectroscopy (FTIR) was performed. In the FTIR spectra of PVDF-HFP (0 wt % ND) and the composites with 1 and 5 wt % NDs, the bands for —CF stretching (1400 cm−1), anti-symmetric —CF2 stretching (1172 cm−1), CF3 out-of-plane stretching/bending (1072 cm−1), and the characteristic bands at 838, 871 and 1168 cm−1 due to 7 phase crystalline structure of PVDF-HFP are observed. The obtained FT-IR spectra are essentially identical to that of pure PVDF-HFP, suggesting non-destructive nature of the membrane fabrication process. After hot press, three stretching positions at 613, 761, 795 and 974 cm−1 corresponding to the a phase of PVDF. This may indicate a phase transition between 7 to a after hot press as well as the impact from acetone as a co-solvent, as observed above.

FIG. 4 shows illustrative examples of electron microscopy imaging (SEM) that reveal non-woven, porous membranes composed of uniform fibers with a diameter of ca. 0.5 μm were produced, but NDs could not be detected. To better observe the NDs and their distribution in the fibers, transmission electron microscopy (TEM) was performed. The TEM images show that individual NDs are relatively uniformly dispersed in patches and there are also domains of agglomerated NDs as well along the polymer matrix. Both the chemical nature and ND surface (e.g., their surface functional groups) and their concentration in the initial dispersion play important roles in their agglomeration during polymer-ND composite fabrication. The fabrication process resulted in NDs/their clusters with diameters in the range of 7-40 nm, which can be confirmed through high-resolution TEM. Smaller (3-5 nm) or larger (40-200 nm) dispersed individual NDs or ND clusters may still be suitable in some designs. The crystalline regions are present in polymer fiber represented by parallel patterns and the distance between the parallel lines were calculated to be ˜0.204 nm which is similar to the interplanar distance of that of NDs. Forming a composite where NDs are not agglomerated is challenging, but could be achieved using energy-intensive methods. A homogeneous dispersion of NDs in polymer matrix can also be achieved through the surface functionalization of NDs, sonication mixing and electrospinning process. As such, the ND dispersion may enable the impartments in the thermal, mechanical, and electrochemical properties for the polymer. Note that in addition to electrospinning other suitable techniques may include, but are not limited to: spraying, electro-spraying, electrophoretic deposition, slurry casting, dip coating, spin coating, phase inversion, dry-laid method, wet-laid method, melt-blown method, melting spinning or force spinning method.

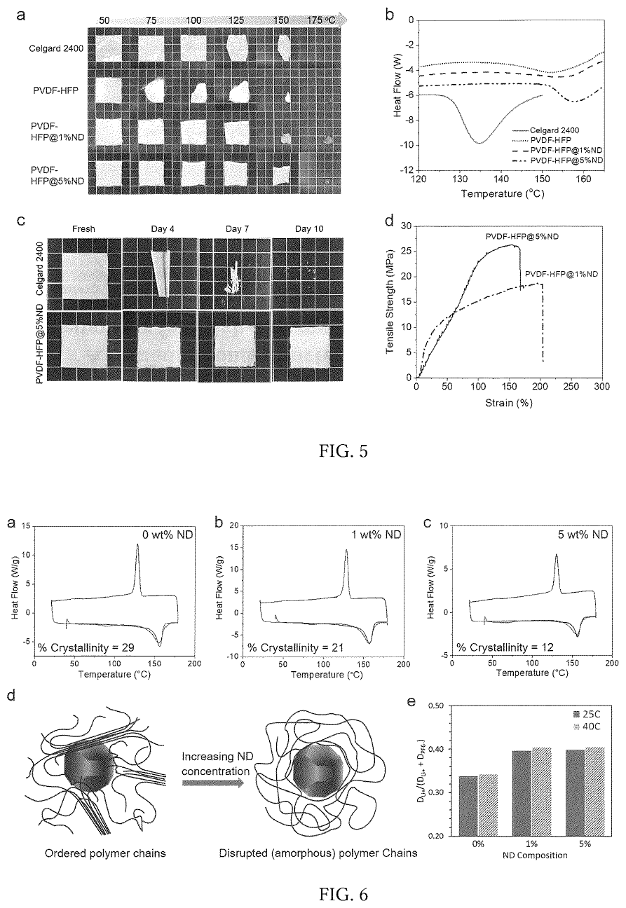

FIG. 5 illustrates an example of thermal stability study of example membranes. Different membranes were heated from 50° C. to 175° C., kept at each temperature for 20 min and checked for their thermal shrinkage. Both commercial (Celgard 2400 PP) and pure PVDF-HFP exhibited rather inferior dimensional stability, and their shrinkages started at as low as 125 and 75° C., respectively. Adding NDs improved the thermal properties, with the onset of shrinkage being approximately 100° C. The PVDF-HFP@5% ND membrane showed much better thermal stability than PVDF-HFP@1% ND. Thermogravimetric analysis (TGA) and differential scanning calorimetry (DSC) were employed to investigate the thermal properties of produced membranes. TGA revealed that these membrane materials are stable up to 150° C., irrespective of the ND concentrations in the sample. The decomposition temperatures (Tds) of both samples were much higher than that of a standard PP separator (130° C.), suggesting a higher heat tolerance of these membranes during processing as well as inside the electrochemical cells. DSC data reveals that increasing the ND concentration in the composite membrane resulted in a higher melting point (Tm) for the polymer. Indeed, the 5 wt % ND-containing separators exhibited the highest Tm of 156° C. and were dimensionally stable at 130° C. for long periods of time. This was seen by heating polymer membrane at 130° C. for 10 days, and the area was calculated during regular intervals. The membrane with 5 wt % ND had a significantly enhanced dimensional stability without a virtually shrinkage at 125° C. In contrast, commercial PP separators could not survive high temperatures, and they started a shrinkage at ca. 120° C. The developed 5 wt % ND-PVDF-HFP composite membranes could serve as a better alternative to the PP separator for long-term LIB cycling, as they are likely to eliminate cell failures due to short circuits caused by thermal shrinkage of the separators at high elevated temperatures. Furthermore, the enhanced Tm and Tm due to ND incorporation allows flexibility in thermal processing; for example, drying of these membranes to remove volatiles can be performed at high temperatures. As the thermal and mechanical properties of PVDF-HFP@5% ND were superior compared to those made with either PVDF-HFP@1% ND or pure PVDF-HFP, the PVDF-HFP@5% ND membranes were used for further electrochemical testing. Gurley value provides an understanding of the tortuosity and porosity of a membrane. While membranes with high tortuosity (low porosity) are desirable for high-energy dense LIBs, the excessive porosity may also cause premature cell failure due to short-circuit caused by the electrodeposited Li dendrites (particularly in case of Li metal anodes) that can easily penetrate the membranes. Therefore, a tradeoff between porosity and tortuosity is typically necessary and is generally achieved through optimization for newly developed membranes. As-synthesized membranes show eda very high air-permeability with an incredibly low Gurley value of only 4 s. Thus, we hot-pressed of the membranes to improve the layer-to-layer stacking and reduce the air-permeability. To allow comparison of electrochemical data obtained from the use of different membranes, their Gurley values were made similar (420 s), through optimization, by densification of the membranes by hot-pressing them for different amounts of time. Depending on the particular cell architecture, a suitable range of Gurley value for the ND-containing composite polymer separator membranes may range from about 10 s to about 1000 s; in some designs, from about 10 s to about 100 s; in other designs, from about 100 s to about 500 s; and in yet other designs, from about 500 s to about 1000 s. In some embodiments, the Gurley value may be from about 10, 50, 60, 70, 80, 90 or 100 s to about 200, 300, 400, 500, 600, 700, 800, 900 or 1000 s. Too small values may lead to undesirable internal shorts, while too high values may reduce rate performance of battery cells to undesirably low values. In this illustrative example, the PVDF-HFP@5% ND membranes required longer time to change the porosity of membrane when compared to PVDF-HFP@1% ND under the applied pressure and heat. Based on the tension tests, the tensile strength of the membranes tends to increase with the increase in ND concentration, with the values for PVDF-HFP@5% ND and @1% ND samples being 25 and 18 MPa, respectively. This difference in the mechanical strength was presumably due to a much stronger polymer-ND interaction, which can overcome the disruption in the packing of polymer chains.

FIG. 6 illustrates example DSC cycles conducted on the membranes in the temperature range 25-175° C. to observe the crystalline behavior change with the increase in ND concentration. The crystallinity (Xc) of PVDF-HFP in the composites was estimated by dividing the enthalpy of fusion (ΔH_f, area under the melting curve) of the samples to that (ΔH_f) of 100% crystalline pure PVDF-HFP, as shown below in the Equation (1).

Xc=(ΔH_f)/(ΔH_f\hat{ }(o))×100% (1)

The crystallinity of pristine PVDF-HFP nanofibers was found to be 29%, which reduced to 12% for 5 wt % ND-PVDF-HFP composite, clearly suggesting that the packing of the polymer chains is disrupted by the presence of NDs. NDs with their high exposed surface areas interacts with the polymer chains, resulting in an overall more amorphous polymer network. This engineered microstructure is beneficial for the facile conduction of Li ions across the polymer surface, which therefore would improve the Li-ion conductivity of the membranes made thereof. Furthermore, the provided utilized NDs contain a negatively charged —Si-PPG surface-modifying group, which is beneficial for improving the Li-ion conductivity via Lewis acid-base-type interactions with the Li ions. This is consistent with the data obtained from the ⁷Li NMR pulse field gradient (PFG) experiment, which suggests that Li-ion diffusivity is enhanced (D_{Li}) with the increase in concentration of the NDs in the composite membranes. At 25° C., the Du of 5 wt % ND sample is 1.12×10-10 m² s⁻¹, which is much higher than pure PVDF-HFP (8.69×10-11 m² s⁻¹) and 1% ND (9.08×10-11 m² s⁻¹), and the Li ion transference number is also higher than that of PE-based separators.

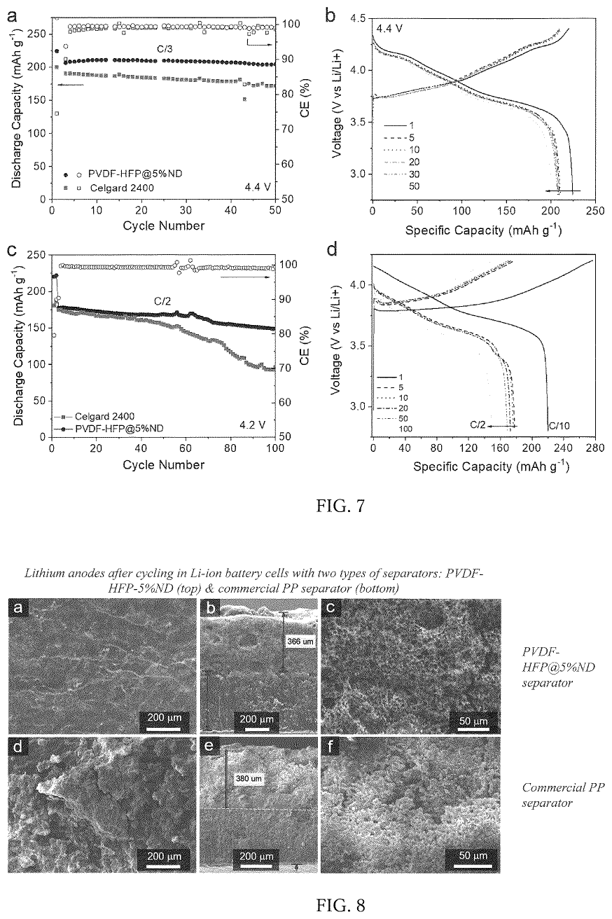

FIG. 7 illustrates example electrochemical properties of different separators were evaluated in coin cells (2032 type) with commercial medium-loading LiNi_{0.8}Mn_{0.1}Co_{0.1}O₂ (NMC811) as a cathode (˜10 mg cm⁻²), Li foil as an anode (or reference electrode) and 1 M LiPF₆ in ethylene carbonate/diethyl carbonate (EC/DEC) as a classical electrolyte used in most publications. To obtain high specific capacity and energy density, the assembled cells were first cycled within a voltage range of 2.8-4.4 V (vs Li/Li+) at a rate of C/3. As can be seen from FIG. 6 item a, the cell with PVDF-HFP@5% ND separator showed more stable performance and higher Coulombic efficiencies (CEs) compared to the one based on conventional separator (Celgard 2400). The initial specific capacity was up to 210 mAh g⁻¹ (stable at the 2^{nd} cycle) and retains 204 mAh g⁻¹ (˜97%) after 50 cycles, while the cell based on Celgard had a fast capacity degradation from 190 to 171 mAh g⁻¹. The stable performance of ND-based separator can be confirmed by their voltage profiles at different charge/discharge cycles. The plateau features were stable as cycles, which meant that the separator is electrochemically stable and did not cause any side reaction. Besides, the PVDF-HFP@5% ND separator can help reduce the voltage hysteresis of the NCM811 cathode, leading to a good reversibility with high energy efficiency. To further probe electrochemical stability of the membranes in the presence of NMC811, we cycled the cells in a lower cutoff voltage of 4.2 V (vs Li/Li+) at C/2. The cell with ND functionalized separator still showed better performance with a higher capacity retention of 149 mAh g⁻¹ and high CE of 99.4% after cycling. The stable performance can be reflected by their voltage profiles at different cycles. Besides, the cyclic voltammetry (CV) scans at a rate of 0.2 mV/s can also suggest that this membrane is stable in the cells. In addition to typical redox peaks for NCM811, there was no additional peaks that would indicate any side reactions—either due to decomposition of the separator or unwanted redox events in the presence of the separator. The electrochemical impedance was evaluated based on the Nyquist plots of the cell before and after cycling, the cells with ND-functionalized separator also show a small semi-cycle after cycling, reflecting a small change in its charge-transfer resistance.

In some embodiments, suitable Li-ion battery cells may preferably include cathode area mass loading (e.g., on one side of the current collector foil) in the range from about −3 mg cm⁻² to about 50 mg cm⁻²; in some designs, from about 3 to about 10 mg cm⁻²; in other designs, from about 10 to about 20 mg cm⁻²; in other designs, from about 20 to about 30 mg cm⁻²; and in other designs, from about 30 to about 50 mg cm⁻². In some embodiments, the cathode area mass loading may be from about 3, 4, 5, 6, 7, 8, 9, 10, 11, 12, 13, 14, 15, 16, 17, 18, 19 or 20 mg cm⁻² to about 20, 21, 22, 23, 24, 25, 26, 27, 28, 29, 30, 35, 40, 45 or 50 mg cm⁻². Too small of mass loading may undesirably reduce gravimetric and volumetric capacity of the batteries, while too large of mass loading may undesirably reduce charging rate and cycle life of the batteries.

It will also be appreciated that suitable Li-ion battery cells may preferably include cathode with area capacity loading (e.g., on one side of the current collector foil) in the range from about 0.5 mAh cm⁻² to about 10 mAh cm⁻²; in some designs, from about 0.5 to about 2.5 mAh cm⁻²; in other designs, t from about 2.5 to about 4 mAh cm⁻²; in other designs, from about 4 to 6 mAh cm⁻²; and in other designs, from about 6 to about 10 mAh cm⁻². In some embodiments, the area capacity loading may be from 0.5, 1, 1.5, 2, 2.5, 3, 4, or 5 mAh cm⁻² to about 5, 6, 7, 8, 9 or 10 mAh cm⁻². Too small of capacity loading may undesirably reduce gravimetric and volumetric capacity of the batteries, while too large of capacity loading may undesirably reduce charging rate and cycle life of the batteries.

In some embodiments, the mass loading of Li-ion battery depends on the gravimetric capacity of active material which may range from about 150 mAh/g to about 2000 mAh/g. The range from about 0.5 mAh cm⁻² to about 10 mAh cm⁻² of area capacity loading of the Li-ion battery may correspond to the range from about 0.25 mg/cm⁻² to about 7 mg/cm⁻² of the mass loading of the Li-ion battery.

FIG. 8 illustrate examples of the selected post-mortem analysis for the cells with different separators after cycling to show additional insight into the changes in Li metal anode and the function of separators. SEM of the Li foils from different cells with ND-functionalized nanofiber (PVDF-HFP@5% ND) and Celgard 2400 PP separators after cycling (2.8-4.2 V vs Li/Li+) was captured. In the top-view SEM images, the Li foil from the cell with PVDF-HFP@5% ND separator is significantly smoother than the one from the cell with PP separator that underwent non-uniform Li deposition with large dendrites. Cross-section SEM images show that a ˜366 um very—thick dendrite surface layers (e.g., mixed solid electrolyte interphase (SEI) and nanostructured Li metal) with a porous structure for the cell with ND-containing separator formed on the anode surface in all cells. However, with PVDF-HFP@5% ND separator, the surface layer was very uniform and porous, which structure may allow ions to more easily penetrate into/extract from the inner dense Li for further plating/striping process. In contrast, with PP separator, a non-uniform deposition/striping of Li which could result in poor packing layer (and slightly larger ˜380 um in thickness), large dead Li particles and cracks were observed. These results indicated our ND-functionalized nanofiber membranes are promising as a separator in LIBs even with a Li metal as anode.

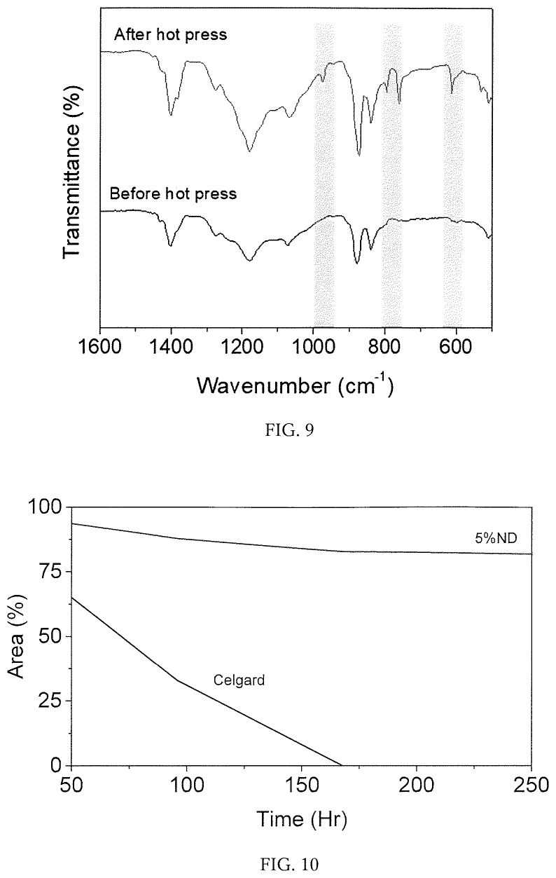

FIG. 9 illustrates example of the FTIR of PVDF-HFP@5% ND membranes before and after hot press.

FIG. 10 illustrates examples of area reduction for commercial and ND-based membranes during storage at 130° C. for 250 h.

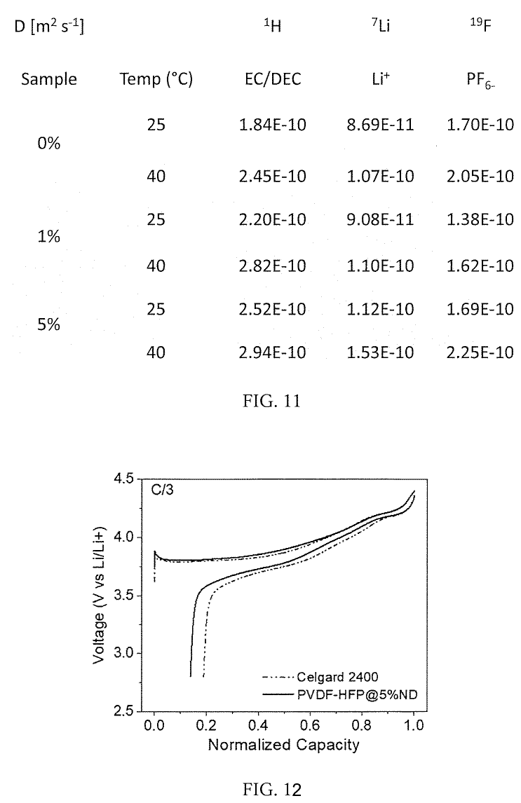

FIG. 11 illustrates example of diffusion coefficients of ¹H, ⁷Li and ¹⁹F for membrane samples with different ND concentrations at 25 and 40° C.

FIG. 12 illustrates example of voltage hysteresis of the cells using commercial and PVDF-HFP@5% ND separators.

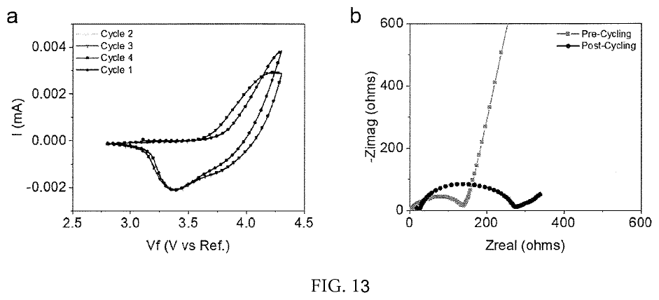

FIG. 13 illustrates example cyclic voltammetry (CV) curves of the cells with PVDF-HFP@5% ND separator at a scan rate of 0.2 mV/s as well as Nyquist plots of the cells before and after long-term cycling at C/2 rate.

In the illustrative example disclosed above, the following procedures were used for synthesis and characterization. ND dispersions (1 wt %) were prepared by mixing 0.017 g of ND-Si-PPG (Daicel Corporation), 2.41 g of N,N-dimethylacetamide (DMAc, Sigma-Aldrich, purity ≥99.5%), and 6.52 g of acetone (Sigma-Aldrich; purity ≥99.8%). The 5 wt % ND dispersions were prepared by mixing 0.11 g of ND-Si-PPG, 2.41 g of DMAc, and 6.52 g of acetone. The dispersions were stirred for 30 minutes at a speed of 300 rpm, and to each solution was added 1.64 g of PVDF-HFP (Sigma-Aldrich avg. Mw ˜455,000). The subsequent mixtures were stirred at 50° C. for 24 h to achieve a homogeneous and viscous gel. The mixed gel was tip-sonicated (Misonix S-4000 at 1 W) for 1 min before electrospinning to further improve the dispersion. Electrospinning was conducted using 3 mL of dispersion for each sample in a syringe and then secured onto a syringe pump to extrude the slurry at a rate of 0.5 mL/h with a rotating drum at 150 rpm. The distance and accelerating voltage between the syringe's tip and the rotating drum were 16 cm and 16 kV. After electrospinning, the subsequent membrane was separated from the aluminum sheet, folded in half, and hot pressed at 110° C. for 2 h under a pressure of 30 MPa using press (Across International, Swingpress) to decrease the porosity. The membranes were then dried for 24 h at 80° C. for subsequent studies. The Hitachi SU8230 was used to take images of the membrane structure after electrospinning. Single polymer composite fibers and ND plane distance was determined by using a transmission electron microscope (Tecnai G2 F30 TEM). Thermogravimetric analysis (TGA) was done using a TA instrument TGA (TA Q600), where the heat was ramped up from room temperature to 400° C. at 5° C./min. Differential scanning calorimetry (DSC, TA instruments Q200) was used to figure out the % crystallinity of the samples with respect to the ND concentration. The temperature of the samples was ramped from room temperature to 160° C. and cooled back to room temperature at 10° C./min. The test was run 4 times to make ensure consistent results between cycles. X-ray diffraction was performed on the Panalytical XPert PRO Alpha-1 XRD instrument by placing the samples on a zero-background holder. To characterize stress/strain behavior of the separators, tensile tests were performed following ASTM D882 Standards using a 25 N force gauge on a Mark-10 ESM303 test stand. Gurley values were obtained by measuring the time taken for 100 mL of air to pass through a fixed area (19.6 cm²) under a pressure of 0.02 MPa using a Gurley Precision Instrument (TROY). In an argon environment inside a glovebox (H₂O<0.1 ppm), 2032-type coin cells were assembled using NMC811 as the cathode, dried membrane as the separator, Li metal as the reference/counter electrode, and 70 μL of 1M LiPF₆ in EC/DEC (1:1, v/v %) as the electrolyte. Cyclic voltammetry (CV) was performed using a Gamry Potentiostat at cycling rate 0.1 mV/s with a step size of 1 mV. The cycling stabilities of the membranes were tested at different C-rate (1C=190 mAh g⁻¹) using an Arbin system. To calculate ionic conductivity, electrochemical Impedance Spectroscopy (EIS) was performed in the frequency range of 1 MHz-0.1 Hz at room temperature. The sample preparation for the pulsed-field gradient (PFG) NMR experiment is very similar to that reported previously. Polymer composites were thoroughly dried at 80° C. for 24 h in a vacuum oven. Then, the polymer composites were stacked together into a 4 mm disc and loaded into a 5 mm diameter NMR probe. The 1M LiPF₆-EC/DEC solution was dropped into the NMR tube to completely soak the membranes. The Bruker AVIIIHD-500 NMR instrument was used to measure diffusion coefficients for different nuclei (D_{Li}, D_{H} and D_{F}) at 25 and 40° C. Pulsed-field gradient spin-echo NMR technique was used to probe the nuclear species: ⁷Li at 116.8 MHz, ¹⁹F at 282.7 MHz, and ¹H at 300.5 MHz.

This description is provided to enable any person skilled in the art to make or use embodiments of the present invention. It will be appreciated, however, that the present invention is not limited to the particular formulations, process stages, and materials disclosed herein, as various modifications to these embodiments will be readily apparent to those skilled in the art. That is, the generic principles defined herein may be applied to other embodiments without departing from the spirit or scope of the invention.

1. A Li-ion battery, comprising:
an anode,
a cathode,
a porous separator membrane that is electrically separating the anode and the cathode, and
an electrolyte that fills pores in the anode, the cathode, and the porous separator membrane, and ionically connects the anode and the cathode,
wherein the porous separator membrane comprises a polymer and nanodiamonds (NDs).

2. The Li-ion battery according to claim 1,
wherein the polymer is in a form of nanofibers.

3. The Li-ion battery according to claim 2,
wherein the nanofibers have an average diameter in a range from 200 to 990 nm.

4. The Li-ion battery according to claim 1,
wherein the NDs are in a form of powders that are dispersed within the nanofibers.

5. The Li-ion battery according to claim 1,
wherein the cathode comprises at least one selected from the group consisting of lithium nickel cobalt manganese oxide (NCM), lithium nickel cobalt aluminum oxide (NCA), lithium cobalt oxide (LCO), lithium manganese oxide (LMO), and lithium iron phosphate (LFP).

6. The Li-ion battery according to claim 1,
wherein the porous separator membrane has a porosity in a range from 40 vol. % to 90 vol.

7. The Li-ion battery according to claim 1,
wherein a thickness of the porous separator membrane ranges from 1 micron to 40 microns.

8. The Li-ion battery according to claim 1,
wherein the polymer comprises at least one selected from the group consisting of a poly(vinylidene fluoride) (PVDF), a poly(hexafluoropropylene) (HFP), and a poly(vinylidene fluoride-co-hexafluoropropylene) (PVDF-HFP) copolymer.

9. The Li-ion battery according to claim 1,
wherein the NDs contain a surface-modifying group containing a polypropylene glycol (PPG) chain.

10. The Li-ion battery according to claim 9, wherein the surface-modifying group has a structure derived from a silane coupling agent containing the PPG chain.

11. The Li-ion battery according to claim 10, wherein the NDs have a structure represented by Formula (1) below:
—Si-PPG-CH₃ (1)
wherein, a bond extending from Si to the left directly or indirectly bonds to the ND.

12. The Li-ion battery according to claim 1, wherein a weight percentage of the NDs in the porous separator membrane ranges from 0.1 wt % to 40 wt %.

13. The Li-ion battery according to claim 1, wherein a weight percentage of the NDs in the porous separator membrane ranges from 0.1 to 1 wt %.

14. The Li-ion battery according to claim 1, wherein a weight percentage of the NDs in the porous separator membrane ranges from 1 to 5 wt %.

15. The Li-ion battery according to claim 1, wherein a weight percentage of the NDs in the porous separator membrane ranges from 5 to 10 wt %.

16. The Li-ion battery according to claim 1, wherein a weight percentage of the NDs in the porous separator membrane ranges from 10 to 20 wt %.

17. The Li-ion battery according to claim 1, wherein a weight percentage of the NDs in the porous separator membrane ranges from 20 to 40 wt %.

18. A porous separator membrane comprising: a nanofiber comprising a polymer and nanodiamonds (NDs), wherein the NDs are uniformly dispersed within the nanofiber.

19. The porous separator membrane according to claim 18, wherein the nanofiber has an average diameter in a range from 200 to 990 nm.

20. The porous separator membrane according to claim 18, wherein the porous separator membrane has a porosity in a range from 40 vol. % to 90 vol. %.

21. The porous separator membrane according to claim 18, wherein a thickness of the porous separator membrane ranges from 1 micron to 40 microns.

22. The porous separator membrane according to claim 18, wherein the polymer comprises at least one selected from the group consisting of a poly(vinylidene fluoride) (PVDF), a poly(hexafluoropropylene) (HFP), and a poly(vinylidene fluoride-co-hexafluoropropylene) (PVDF-HFP) copolymer.

23. The porous separator membrane according to claim 18, wherein the NDs contain a surface-modifying group containing a polypropylene glycol (PPG) chain.

24. The porous separator membrane according to claim 23, wherein the surface-modifying group has a structure derived from a silane coupling agent containing the PPG chain.

25. The porous separator membrane according to claim 24, wherein the silane coupling agent has a structure represented by Formula (1) below:
—Si-PPG-CH₃ (1)
wherein, a bond extending from Si to the left directly or indirectly bonds to the ND.

26. The porous separator membrane according to claim 18, wherein a weight percentage of the NDs in the porous separator membrane ranges from 0.1 wt % to 40 wt %.

27. The porous separator membrane according to claim 18, wherein a weight percentage of the NDs in the porous separator membrane ranges from 0.1 to 1 wt %.

28. The porous separator membrane according to claim 18, wherein a weight percentage of the NDs in the porous separator membrane ranges from 1 to 5 wt %.

29. The porous separator membrane according to claim 18, wherein a weight percentage of the NDs in the porous separator membrane ranges from 5 to 10 wt %.

30. The porous separator membrane according to claim 18, wherein a weight percentage of the NDs in the porous separator membrane ranges from 10 to 20 wt %.

31. The porous separator membrane according to claim 18, wherein a weight percentage of the NDs in the porous separator membrane ranges from 20 to 40 wt %.

32. A method of generating a porous separator membrane, comprising:
preparing a mixed polymer gel by mixing nanodiamonds (NDs) and a polymer in NMP solvent, wherein the NDs are surface-modified using ball milling of polypropylene glycol (PPG) and a silane coupling agent to provide NDs containing a surface-modifying group, and the NDs are homogeneously dispersed in the polymer gel; and
electrospinning the mixed polymer gel to generate nanofibers.

33. The method according to claim 32, wherein the NDs are uniformly dispersed in the nanofibers.

34. The method according to claim 33, wherein the nanofibers have an average diameter in a range from 200 to 990 nm.

35. The method according to claim 32, wherein the porous separator membrane has a porosity in a range from 40 vol. % to 90 vol. %.

36. The method according to claim 32, wherein a thickness of the porous separator membrane ranges from 1 micron to 40 microns.

37. The method according to claim 32, wherein the porous separator membrane comprises at least one selected from the group consisting of a poly(vinylidene fluoride) (PVDF), a poly(hexafluoropropylene) (HFP), and a poly(vinylidene fluoride-co-hexafluoropropylene) (PVDF-HFP) copolymer.

38. The method according to claim 32, wherein the silane coupling agent has a structure represented by Formula (2) below:
R₃—Si-PPG-CH₃ (2)
wherein, R represents an identical or different alkoxy group.

39. The method according to claim 32, wherein a weight percentage of the NDs in the porous separator membrane ranges from 0.1 wt % to 40 wt %.

40. The method according to claim 32, wherein a weight percentage of the NDs in the porous separator membrane ranges from 0.1 to 1 wt %.

41. The method according to claim 32, wherein a weight percentage of the NDs in the porous separator membrane ranges from 1 to 5 wt %.

42. The method according to claim 32, wherein a weight percentage of the NDs in the porous separator membrane ranges from 5 to 10 wt %.

43. The method according to claim 32, wherein a weight percentage of the NDs in the porous separator membrane ranges from 10 to 20 wt %.

44. The method according to claim 32, wherein a weight percentage of the NDs in the porous separator membrane ranges from 20 to 40 wt %.
